(19) United States
(12) Patent Application Publication
(10) Pub. No.: US 2007/0296201 A1
(43) Pub. Date: Dec. 27, 2007

(54) Bookmark With Light

(76) Inventors: Mark C. Grossmeyer, Cedarburg, WI (US); Charles T. Leung, Hillsborough, CA (US)

Correspondence Address: BOYLE FREDRICKSON S.C., 840 North Plankinton Avenue, MILWAUKEE, WI, 53203, US

(21) Appl. No.: 11/738,299

(22) Filed: Apr. 20, 2007

Related U.S. Application Data
(60) Provisional application No. 60/794,260, filed on Apr. 21, 2006.

(51) Int. Cl. B42D 9/00

(52) U.S. Cl. 281/42; 362/190

(57) ABSTRACT

A bookmark that includes a light which can be carried by a book to light a page presented for viewing for reading. A portion of the bookmark is manipulable relative to another portion of the bookmark between a bookmark position and a light operating position with one of the portions receivable between a pair of pages of the book underlying the page presented for viewing that is lit by the light. One portion preferably includes a segment and the other portion preferably includes a segment with a joint that preferably includes a hinge disposed therebetween. A position actuated switch cooperates with at least one of the segments to turn on the light when the bookmark is manipulated into the light operating position. Such a bookmark can be configured to provide additional functions such as a magnifier, a picture frame, a clock and/or a calculator.

### CROSS REFERENCE TO RELATED APPLICATION

This application claims priority under 35 U.S.C. §119(e) to U.S. Provisional Patent Application No. 60/794,260, filed Apr. 21, 2006, the entirety of which is hereby expressly incorporated by reference herein.

### FIELD OF THE INVENTION

The present invention relates to a bookmark and more particularly to a bookmark equipped with a light that can be of multifunction construction.

### BACKGROUND

Bookmarks in typical use today usually consist of a thin, elongate strip of thin material, often made of plastic or paper, which is placed in between pages of a book or notebook to mark a particular page of the book or notebook. Thus, the primary purpose of a bookmark is to mark the particular page where a person stopped reading so the person can return to that page and start reading again at that page when they want to continue reading. The function of a bookmark therefore it is useful only when the person is not reading. In fact, when reading such a bookmark does not serve a purpose and oftentimes gets in the way during reading such that it can become separated from the book or notebook and lost.

A portable reading light, on the other hand, is typically only used when a person is reading a book or notebook. This usually occurs after any bookmark has been removed from the book or notebook and placed to the side. A portable reading light is particularly helpful because it assists a reader in reading a book in a relatively dark environment by illuminating the page being read.

There is an assortment of reading lights that are clipped to the book in some manner, which typically must be done in order to use them during reading. When finished reading, they must be removed from the book and put in a place where they typically remain separated from the book until the next time they are used. Since they are not intended to remain with the book, it is easy for such a prior art reading light to become misplaced and even lost. Another disadvantage of these prior art reading lights is that they typically require some sort of a mechanism that clips or clamps the light to some part of the book. This additional structure disadvantageously adds weight and increases the size of the reading light. Another disadvantage is that reading lights cannot be used to mark a particular page of a book, like a bookmark can, and are not always with the book when needed. A still further disadvantage of prior art reading lights is that they frequently require adjustment to optimally light an area on a page being read.

What is needed is a more versatile bookmark. What is also needed is a reading light that more readily remains with a book when the book is not being read.

### SUMMARY

The present invention is directed to a bookmark of multi-function construction that includes a light and that is movable between a bookmark operating position where the bookmark is usable as a bookmark and a light operating position where the bookmark is usable as a reading light. Such a bookmark therefore is configured to provide a plurality of functions with one of the functions, of course, being a bookmark and a second one of the functions being a reading light. If desired, the reading light can also be used to illuminate objects other than a page of an opened book presented for viewing by a reader of the book.

A multi-function bookmark constructed in accordance with the invention can be configured to provide additional functions. For example, such a multi-function bookmark can be configured to include a magnifier, a picture frame, a clock, or a calculator.

A multi-function bookmark constructed in accordance with the invention includes a plurality of bookmark segments with the light being carried by one of the bookmark segments. The bookmark segments are manipulable, such as by a reader of a book, between the bookmark operating position where a substantial portion of the bookmark is substantially planar and the light operating position where one portion of the bookmark is disposed at an angle relative to another portion of the bookmark.

When the bookmark is disposed in the substantially planar bookmark operating position, it can be inserted between a pair of adjacent pages of the book to mark a reading position. In a preferred embodiment, the plurality of bookmark segments are disposed along a common plane such that a substantial part of the bookmark preferably is substantially planar. In a preferred embodiment, the entire bookmark is substantially planar when disposed in the bookmark operating position.

When the bookmark is disposed in the light operating position, one portion of the bookmark is received between a pair of pages that underlie the page of the book presented for viewing by a reader of the book when the book is open and the other portion carries the light and positions the light above the page presented for viewing. When the bookmark is disposed in the light operating position, the one portion of the bookmark is substantially planar so it can be slidably received between the pair of pages that underlie the page presented for viewing and the second portion is disposed at an angle relative to the first portion such that it disposes the light above the page presented for viewing. In a preferred embodiment, the one portion of the bookmark includes at least one of the plurality of bookmark segments and the other portion of the bookmark includes at least one of the plurality of bookmark segments.

In a currently preferred embodiment, there are a pair of bookmark segments with one of the bookmark segments being elongate and generally planar for being received between the plurality of pages that underlie the page presented for viewing anchoring the bookmark therebetween. The other bookmark segment preferably also is elongate and generally planar with a joint between the bookmark segments enabling one of the bookmark segments to be manipulated relative to the other one of the bookmark segments between the bookmark operating position and the light operating position. In a preferred embodiment, each segment is a generally planar and elongate panel that can be of generally rectangular construction.

An electrical switch arrangement disposed onboard one of the bookmark segments preferably is cooperable with the other one of the bookmark segments and can be cooperable with the joint enabling an onboard electrical power supply to supply electrical power to the light at least when the bookmark segments are disposed in a light operating position and to break electrical power flow to the light when disposed in the bookmark operating position. In a preferred embodiment, the electrical switch arrangement is configured to break electrical power flow to the light when the bookmark segments are disposed in a position away from the light operating position that need not be the bookmark operating position.

The electrical switch arrangement includes a switch with a switch actuator carried by one bookmark segment that cooperates with the other bookmark segment to close the switch when the bookmark segments are disposed in the light operating position. In a preferred embodiment, the switch actuator is disposed at or adjacent the joint. In a preferred embodiment, relative movement of the bookmark segments toward the light operating position displaces the switch actuator or a portion thereof until the switch is closed when the bookmark segments are disposed in the light operating position.

In a preferred bookmark embodiment, the joint includes a hinge or is a hinge. Such a hinge preferably includes at least one hinge knuckle carried by one of the bookmark segments that engages at least one hinge knuckle carried by the other one of the bookmark segments. In a preferred embodiment, at least one detent is provided that enables the bookmark segments to remain in the light operating position. In a preferred embodiment, there can be a detent that enables the bookmark segments to remain in the bookmark operating position. In each case, each such detent provided preferably releasably retains the bookmark segments in a corresponding one of the light and bookmark operating positions.

In a preferred hinge embodiment, a detent is formed by an upraised projection of one of the hinge knuckles of one of the bookmark segments that interferes against a part of a hinge knuckle recess that preferably is formed in the other one of the bookmark segments. In a preferred hinge embodiment, there are a plurality of such detents with one of the detents configured to releasably retain the bookmark segments in a light operating position and the other one of the detents configured to releasably retain the bookmark segments in the bookmark operating position.

The light preferably is carried by one of the segments and is oriented with its optical central light emitting axis disposed at an acute angle relative to the surface of the page of the book presented for viewing when the book is opened and the bookmark in the light operating position with its anchor bookmark segment received between a pair of the underlying pages. In a preferred embodiment where the light-carrying bookmark segment is elongate and substantially planar, the light is mounted to the bookmark segment and preferably oriented such that its optical central light emitting axis is disposed at an acute angle relative to the light-carrying bookmark segment along at least one set of axes relative to the bookmark segment. In a preferred embodiment, the light is oriented with its optical central light emitting axis relative to a plurality of sets of axes relative to the light-carrying bookmark segment.

In a preferred embodiment, when disposed in the light operating position, the light is disposed at a sufficient height that it illuminates a portion of at least one of the pages presented for viewing when the book is open and preferably both of the pages presented for viewing when the book is opened. When so oriented relative to the light-carrying bookmark segment to which it is mounted and disposed at such a sufficient height, the light preferably illuminates substantially the entirety of at least one of the pages presented for viewing and preferably illuminates substantially the entirety of both of the pages presented for viewing.

Objects, advantages and features of the present invention include providing a bookmark that is capable of also functioning as a reading light; a bookmark which can be configured to provide at least one other function in addition to that of being a bookmark and a reading light; and a bookmark which can be molded of plastic; which is simple and easy to use; of economical construction; of robust, reliable and simple manufacture; is easy to make and use; and which is of versatile and user friendly construction.

Numerous other aspects, features and advantages of the present invention will be made apparent from the following detailed description taken together with the below-described accompanying drawing figures.

### BRIEF DESCRIPTION OF THE DRAWINGS

One or more preferred exemplary embodiments of the invention are illustrated in the accompanying drawings in which like reference numerals represent like parts throughout and in which:

FIG. 1 is a perspective view of a multi-function bookmark disposed in a bookmark operating position and having a reading light constructed in accordance with the present invention;

FIG. 2 is a side elevation view of the bookmark of FIG. 1;

FIG. 3 is an end elevation view of the bookmark of FIG. 1;

FIG. 4 is a perspective view of the bookmark of FIG. 1 showing the bookmark disposed in a reading light operating position;

FIG. 5 is a partial, fragmentary, cross sectional view illustrating details of a housing of one or more bookmark segments;

FIG. 6 is a side elevation view of a second preferred multi-function bookmark embodiment showing a pair of bookmark segments folded over one another;

FIG. 7 illustrates the bookmark of FIG. 6 in a reading light operating position;

FIG. 8 shows the bookmark of FIG. 7 with its segments being manipulated toward the bookmark operating position;

FIG. 9 shows the bookmark in FIG. 7 disposed in a bookmark operating position;

FIG. 10 illustrates a third preferred embodiment of a multi-function bookmark in a folded position;

FIG. 11 shows the bookmark of FIG. 10 disposed in a bookmark operating position;

FIG. 12 illustrates a bookmark light electrical circuit schematic;

FIG. 13 is a top plan view of a preferred embodiment of a bookmark light electrical circuit implementation;

FIG. 14 is a bottom plan view of the bookmark of FIG. 1 showing details of its construction;

FIG. 15 is a top plan view of the bookmark of FIG. 1 showing additional details of its construction;

FIG. 16 is a perspective view of a multi-function bookmark constructed in accordance with the present invention inserted into a book and being used as a bookmark;

FIG. 17 is a perspective view of the bookmark of FIG. 16 being positioned between a pair of pages other than the page or pages being read in preparation for use as a reading light;

FIG. 18 is a perspective view of the bookmark of FIG. 16 showing it in use as a reading light;

FIG. 19 is a top plan view of the book and bookmark of FIG. 16 showing a corresponding field of illumination pattern of the multi-function bookmark along X-Y axes when used as a reading light; and

FIG. 20 is a side elevation view of the book and bookmark of FIG. 16 showing a corresponding field of illumination along Y-Z axes.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

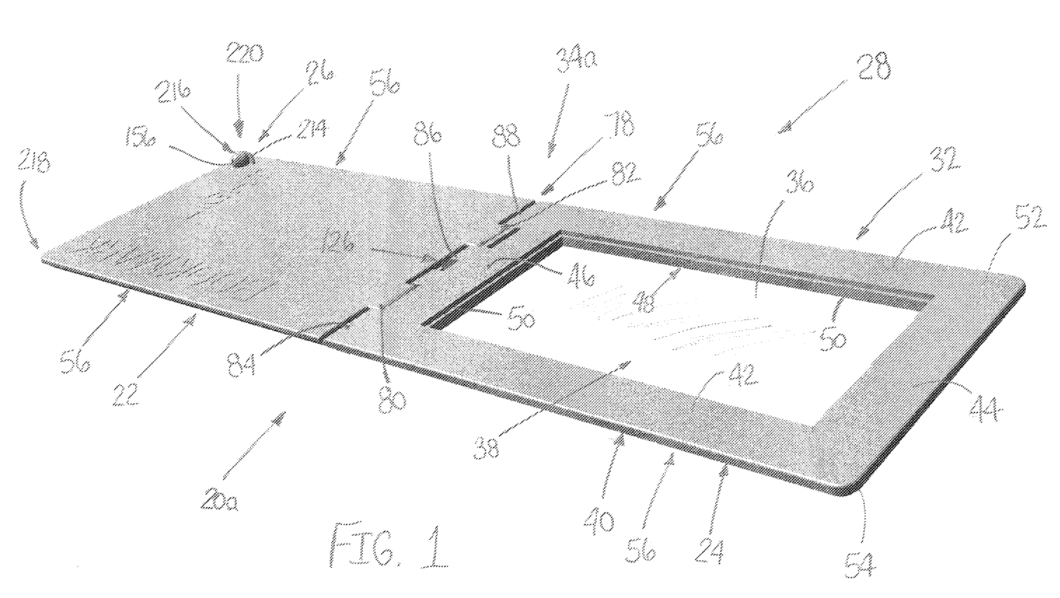

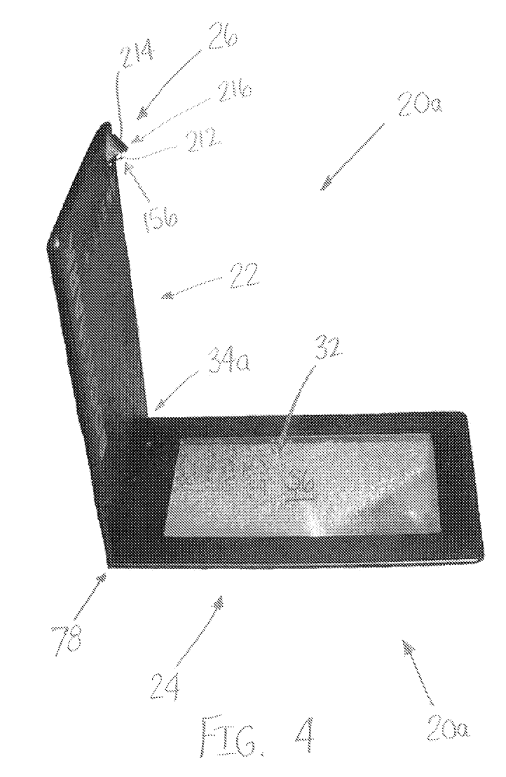

FIGS. 1-4 illustrate a preferred embodiment of a multi-function bookmark 20a constructed in accordance with the present invention that includes at least one bookmark segment 22, 24 and an integral reading light 26 that can be selectively activated, such as preferably when a person reading a book desires to illuminate a portion of one or more pages of the book. Preferably, each segment 22, 24 is a generally flat or substantially planar panel that can be and preferably is generally rectangular. As is shown in FIGS. 1 and 4, the bookmark 20 is manipulable between a substantially flat and planar bookmark position 28 and an inclined or angled reading light operating position 30 where the light 26 preferably energizes to illuminate at least a substantial portion of one or more pages of a book. In at least one preferred embodiment, the bookmark 20 can also include an integral magnifier 32 such that a bookmark constructed in accordance with the present invention is configured to provide a plurality of functions and can be configured to provide at least a plurality of pairs of, i.e. at least three, functions: (1) a bookmark, (2) a reading light, and (3) a magnifier.

The bookmark 20a includes at least one joint 34a that divides the bookmark into a plurality of segments 22, 24 with one of the segments 22 carrying the reading light 26 and the other one of the segments 24 carrying an integral magnifier 32. The magnifier 32 includes a lens 36 that is seated in an aperture 38 in a frame 40 formed in bookmark segment 24 that includes a pair of longitudinally extending rails 42 and a pair of transversely extending legs 44, 46. The aperture 38 preferably defines a lens seat 48 that is formed by a stepped offset or land 50 that extends along an inner peripheral edge of the frame 40 upon which a corresponding outer peripheral edge of the lens 36 is supported.

The lens 36 can be anchored or otherwise suitably attached to bookmark segment 24 in just about any manner. In a preferred embodiment, the lens 36 is retained in the frame 40 of segment 24 by being captured between a top segment half 52 and a bottom segment half 54. The top segment half 52 and bottom segment half 54 preferably are attached, joined or connected in a manner that retains the lens 36 in place. For example and as discussed below, an arrangement, such as a friction fit, a snap fit, a fastener arrangement, an adhesive or the like, can be employed to keep or help keep the halves 52 and 54 together as well as can be used to keep or help keep the lens 36 fixed to segment 24.

The lens 36 can be composed of glass but preferably is of synthetic construction, e.g., plastic. In a preferred embodiment, the lens 36 is a generally rectangular plastic lens that preferably is of Fresnel construction. While the lens 36 depicted in FIG. 1 is generally rectangular, it should be noted that other magnifying lens shapes can be used. For example, an oval, oblong or circular lens shape can be used. Of course, where the shape of the lens differs from that which is shown in FIG. 1, the shape of the frame preferably is adapted to accommodate the particular shape of the lens.

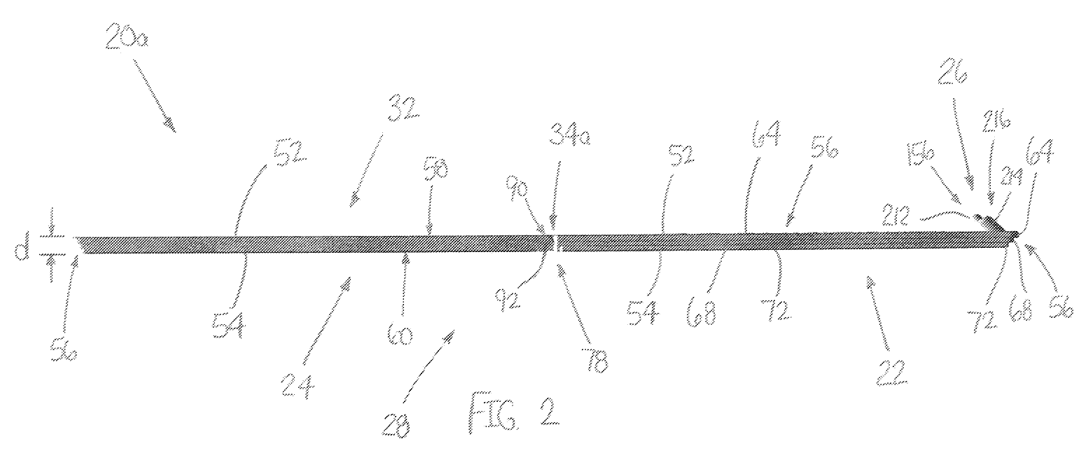

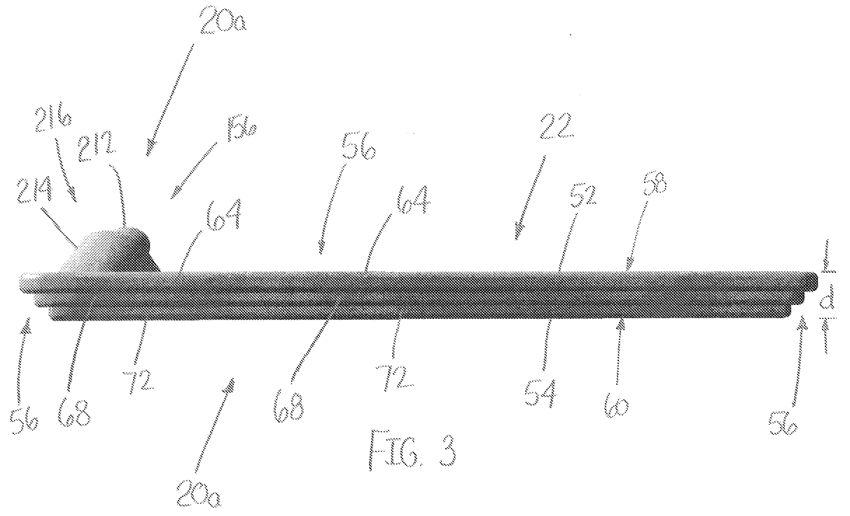

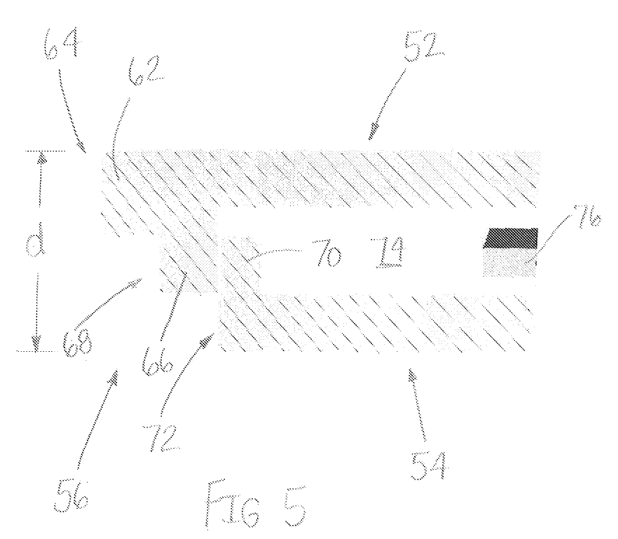

With reference to FIGS. 2 and 3 and additional reference to FIG. 5, at least one bookmark side edge preferably is tapered 56 to help facilitate insertion and retention of any portion of the bookmark 20a into and toward a spine of a book. Where tapered, the corresponding bookmark segment 22 and/or 24 has a transverse side-to-side width along one of a top and bottom surface of at least one of the segments that is wider than the corresponding transverse side-to-side width of the other one of the top and bottom surface of the at least one of the segments. For example, as is best shown in FIG. 3, both sides are tapered edges 56 such that the transverse side-to-side width of a top surface 58 of both segments 22, 24 is wider than a bottom surface 60 of the segments 22, 24.

In a preferred embodiment, at least the longitudinally extending side edge opposite the side of the light 26 is a tapered edge 56. In the preferred embodiment shown in FIGS. 1-4, both longitudinally extending side edges are tapered edges 56. If desired, the edge of each transversely extending end of the bookmark 20a can also be tapered in the same or a like manner. In the preferred embodiment shown in FIGS. 1-4, the edge along each transversely extending end is also tapered.

With continued reference to FIGS. 2 and 3, the cross sectional thickness, d, of the bookmark 20a preferably is no more than about five millimeters such that the bookmark 20a can internally accommodate an internal source of electrical power for the light 26 while still being thin enough to be inserted and retained between pages of a book. The combination of providing the bookmark 20a with tapered longitudinally extending side edges 56 and a relatively thin cross sectional thickness, d, of no more than about five millimeters, enables a bookmark 20a constructed in accordance with the present invention that is equipped with an integral light 26 to be releasably received and positively retained in between pages of a book.

FIG. 5 illustrates a preferred cross sectional configuration for both bookmark segments 22, 24 with both segments 22, 24 being made of front and rear segment halves 52, 54 that can engage one another in forming respective segments 22, 24 while at the same time achieving a tapered edge 56 along at least one and preferably both longitudinally extending side edges. Each segment half 52, 54 preferably is made of plastic but can be made of another suitable durable, lightweight and thin material including metal or the like.

Although not shown in FIG. 5, both segment halves 52, 54 can be configured so as to engage one another to retain the halves 52, 54 together in assembling the bookmark 20a. For example, in one preferred embodiment, the halves 52, 54 are formed to be of snap-fit construction such that they can quickly and easily snap together during assembly. If desired, a fastening arrangement, such as screws, hook-and-loop fasteners, or the like can also be used.

To form the desired tapered outer side edge 56, the top segment half 52 has an outwardly extending flange 62 that forms a first tapered edge step 64 and a down-turned skirt 66 that forms a second tapered edge step 68 overlaps at least part of an upstanding lip 70 of the bottom segment half 54. The bottom outer edge of segment half 54 adjacent the lip 70 forms a third tapered edge step 72 as shown in FIG. 5. Although not shown in FIG. 5, skirt 66 and lip 70 can be configured to engage one another during assembly, such as by being configured for direct snap-fit engagement therebetween, to help keep both segment halves 52, 54 attached once assembly is completed.

When the segments halves 52, 54 of each bookmark segment 22, 24 are assembled, they preferably define a hollow chamber or compartment 74 in which one or more components related to bookmark function are housed. For example, as is depicted in FIG. 5, segment halves 52, 54 define a compartment 74 in which at least one electrical component 76, such as a battery, a terminal, a contact or the like, is housed.

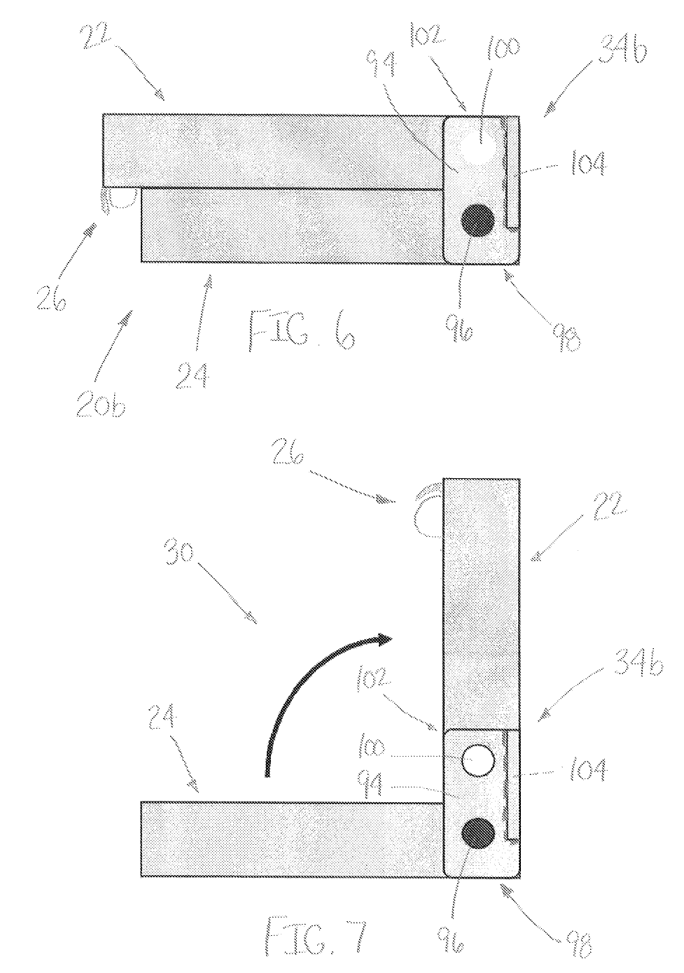

Referring once again to FIG. 1, the joint 34a is formed of a hinge 78 composed of a plurality of spaced apart outwardly extending knuckles 80, 82 of one segment 22 that are each disposed between a pair of a plurality of pairs of spaced apart knuckles 84, 86, 88 of the other segment 24. The joint 34a preferably is of single-degree of freedom construction that is configured to permit relative rotation between the segments 22, 24. This construction enables the bookmark 20a to be manipulated between (1) a bookmark position, such as the bookmark position 28 shown in FIG. 1, where both segments 22, 24 are substantially aligned forming a flat bookmark and (2) a reading light operating position, such as the reading light operating position 30 shown in FIG. 6, where the segment 24 with the light 26 is disposed at an angle relative to the other segment 22. When the bookmark 20a is disposed in the reading light operating position 30, the segment 24 opposite the light-carrying segment 22 serves as reading light anchor that is placed in between pages of a book.

With additional reference to FIG. 2, while the knuckles 80, 82, 84, 86 and 88 can be constructed to engage one another in a manner that keeps the segments 22, 24 together while enabling relative segment rotation, the hinge 78 preferably includes a pivot 90 that is a pin 92 that extends through at least a plurality of the knuckles 80, 82, 84, 86 and 88. In a preferred embodiment, the pin 92 extends transversely relative to the bookmark 20a through at least a portion of each one of the knuckles 80, 82, 84, 86 and 88 permitting relative rotation between the pin 92 and each one of the knuckles 80, 82, 84, 86 and 88 during relative segment rotation. Of course, the pin 92 also acts as a retainer that helps keep the segments 22, 24 from separating from one another.

FIGS. 6-9 illustrates a second preferred embodiment of a multifunction bookmark 20b constructed in accordance with the present invention that has a modified joint 34b that is of articulating construction. Articulated joint 34b includes a connecting link 94 that is pivotally connected at or adjacent one end to bookmark segment 22 at a first pivot 96 of a first hinge 98 and that is pivotally connected at or adjacent it other end to bookmark segment 24 by a second pivot 100 of a second hinge 102. The articulated joint 34b advantageously enables a greater amount of freedom of relative motion between the bookmark segments 22, 24 by enabling one segment 22 to be folded on top of the other segment 24 such as is in the manner depicted in FIG. 6.

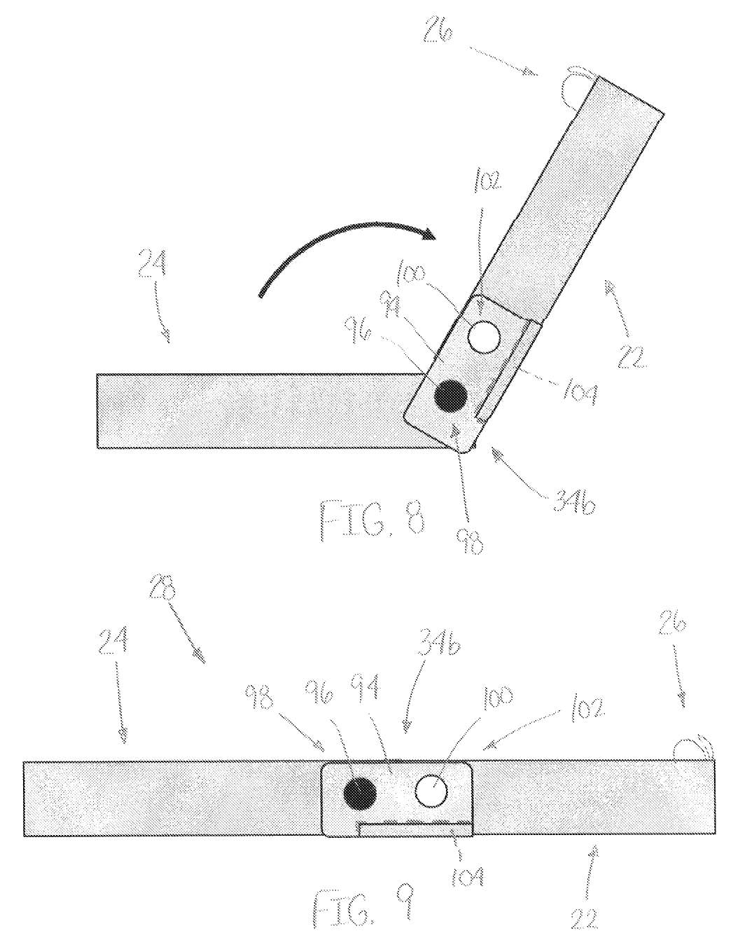

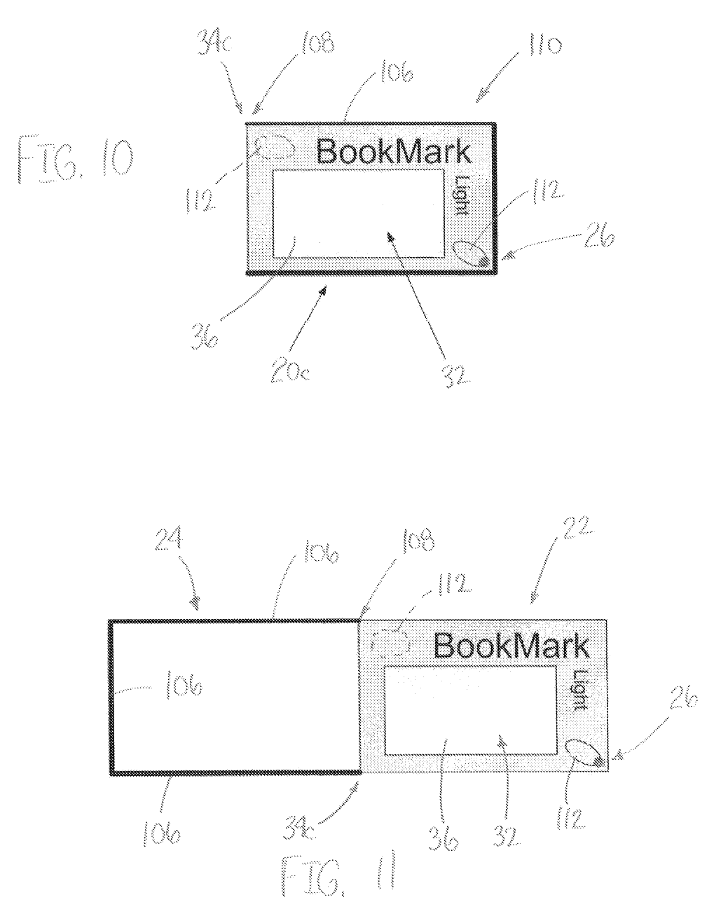

Preferably there is a plurality of connecting links 94 that are transversely spaced apart along the joint 34b to facilitate articulating hinge operation along substantially the entire length of the joint 34b. Each link 94 includes a flange 104 (shown in phantom in FIGS. 6-9) that projects outwardly and functions as an abutment that bears against part of bookmark segment 22 when the segment 22 is rotated relative to segment 24 back past the substantially perpendicular reading light operating position 30 shown in FIG. 7 toward the bookmark position 28 shown in FIG. 9. As the light-carrying bookmark segment 22 is rotated beyond the approximately 90° position shown in FIG. 7 toward the bookmark position 28, part of the bottom surface 60 of segment 22 bears against the abutment flange 104 causing the link 94 and segment 22 to move substantially in unison as shown in FIG. 8. When segment 22 reaches the fully extended bookmark position 28 shown in FIG. 9, the abutment flange 104 bears against an end of the other segment 24 preventing over-rotation of either segment 22, 24 beyond the bookmark position 28 in the opposite direction.

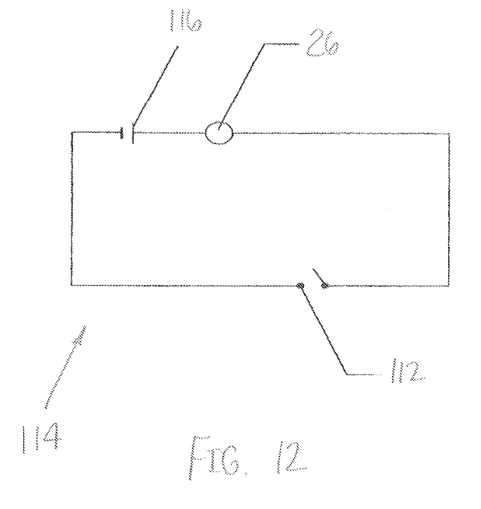

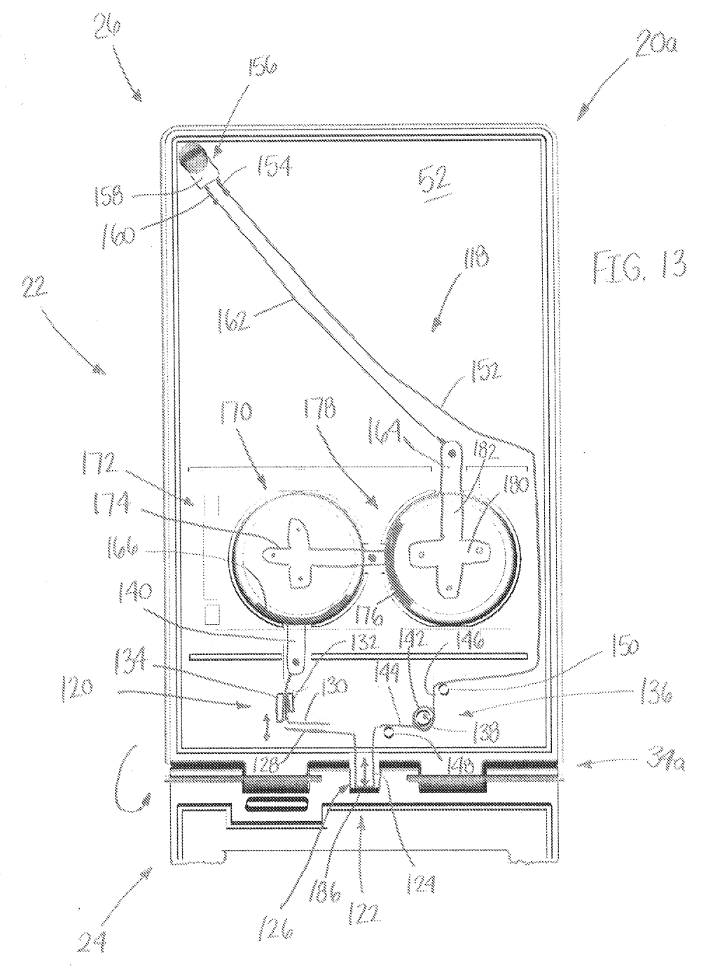

FIGS. 10-11 illustrate a third preferred embodiment of a multifunction book mark 20c that also is equipped with a reading light 26. The bookmark 20c has a light-carrying segment 22 that also preferably also carries lens 36 of magnifier 32. The other bookmark segment 24 is formed of a wire frame 106 of generally rectangular or U-shaped construction that is pivotally attached at or adjacent one end to segment 22. Pivotal attachment preferably is via a joint 34c that includes a pivot 108, such as a pin or the like (not shown in FIGS. 10 and 11), which extends transversely through at least part of segment 22. As a result of pivotal attachment, segment 24 can be folded over segment 22 such that segment 22 nests within it. Since segment stacking does not occur, the total cross sectional thickness of the bookmark 20c is no greater than the segment 22 or 24 having the greatest cross sectional thickness. The result is a bookmark 20c capable of being quickly and easily folded into an ultra-compact storage position 110 shown in FIG. 10 that advantageously enables it to be conveniently carried in a pocket, a purse, a wallet or the like. While the wire frame 106 preferably is made of metal, it can also be made of plastic or another suitable material.

Where the reading light 26 does not employ a switching arrangement that energizes the light 26 based on the position of one segment 22 relative to the other segment 24, one of the segments 22 can be equipped with an integral switch 112 that can be manually actuated by a user. While the switch 112 is shown located adjacent the light 26 in FIGS. 10 and 11, it can also be located distal the light such as the switch shown in phantom in FIGS. 10 and 11. Switch 112 preferably is of touch sensitive construction such that it can be a membrane switch or a capacitance switch.

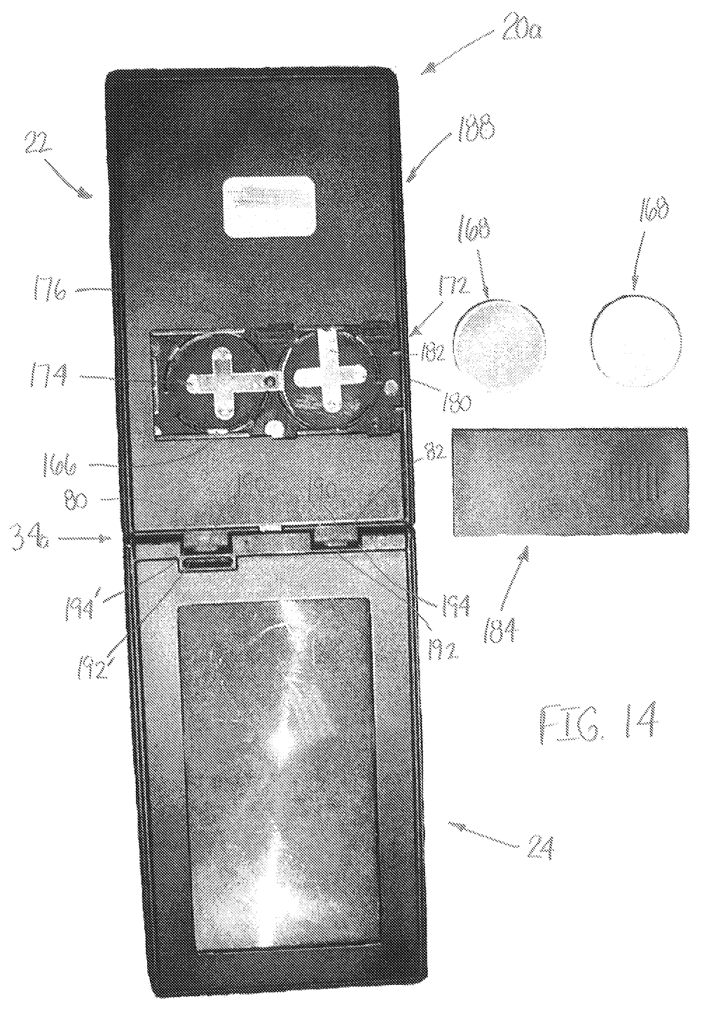

FIG. 12 depicts a schematic of a reading light circuit 114 that includes a switch, such as switch 112, which is located onboard the bookmark, the reading light 26, and an onboard electric power source 116 that preferably is a battery. The electrical circuitry of circuit schematic 114 is self-contained onboard bookmark segment 22 with at least the battery 116 preferably being disposed within the segment 22. In the preferred bookmark embodiment shown in FIGS. 10 and 11, the switch 112 is also disposed within the segment 22 with its switch actuator positioned so it can be manipulated by a user to turn the light 26 on or off as desired.

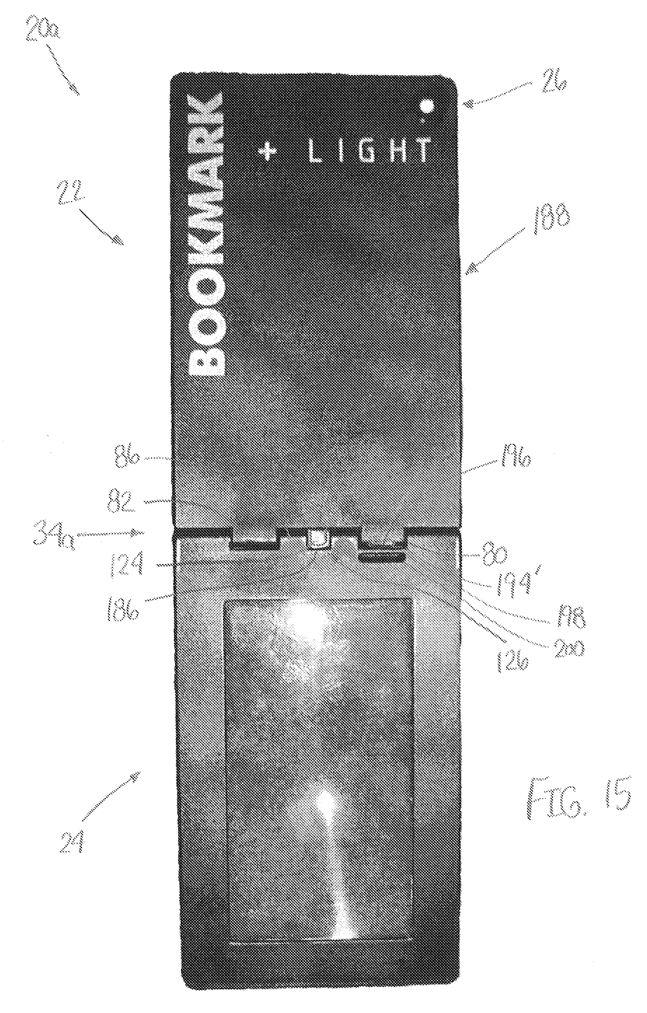

FIGS. 13-15 illustrate a preferred implementation of a position-sensitive reading light switching circuit implementation 118 of the reading light circuit schematic of FIG. 12. FIG. 13 illustrates the light-carrying segment 22 with the bottom segment half 54 removed to show the circuit implementation 118 in detail. The circuit implementation 118 includes a switch assembly 120 that has a switch actuator 122 that includes a substantially rigid actuator loop 124 that is disposed in a pocket 126 formed in hinge knuckle 86 of the anchor segment 24. The switch actuator 122 includes a movable contact 128 spaced by a gap from a fixed contact 130 supported by a pair of contact guides 132, 134 formed in the top segment half 52 of the light-carrying bookmark segment 22 when the bookmark 20a is disposed in the bookmark position 28. The switch actuator 122 also includes an electrically conductive torsion spring 136 carried by a torsion spring support post 138 formed in segment half 52 of segment 22. The fixed contact 130 is connected to a first battery output terminal 140.

The torsion spring 132 preferably is of helical construction having its coil 142 encircling the torsion spring support post 138 in the manner depicted in FIG. 13. The torsion spring 132 also has a pair of spring ends 144, 146 with one of the spring ends 144 bounded by a first spring support 148 and the other one of the spring ends 146 bounded by a second spring support 150 that preloads the torsion spring 132 in a manner such that the light switch contacts 128, 130 are normally open when the bookmark 20a is disposed in the bookmark position 28.

An electrical lead 152, preferably an electric current carrying wire that can be electrically insulated, extends from the torsion spring 136 to a terminal 154 of a light emitting source 156 that preferably is a light emitting diode 158. While a light emitting diode 158 is preferred, a miniature incandescent bulb could also be used. The other terminal 160 of the light source 156 is connected to an electrical lead 162 that is, in turn, attached to a second battery output terminal 164.

With additional reference to FIG. 14, the first battery output terminal 140 is attached to a positive contact 166 that makes an electrical connection with a positive power electrode of a button cell battery 168 inserted into a first button cell battery holder 170 disposed within a battery compartment 172 formed in the bottom segment half 54 of the light-carrying bookmark segment 22. The first battery holder 170 includes a negative contact 174 that leads to a positive contact 176 of an adjacent button cell battery holder 178 connecting the button cell batteries in series when they are inserted into the battery compartment 172. A negative contact 180 of the second button cell battery holder 178 makes electrical contact with the negative electrode of button cell 168 when it is inserted into battery holder 178. The contact 180 has an elongate extension 182 that leads to and also forms the second battery output terminal 164, as best shown in FIG. 13. The battery compartment 172 can be enclosed by a cover 184 (FIG. 14) that slides over the compartment 172 into engagement with segment half 54 of segment 22.

With reference to FIG. 14, each button cell 168 is relatively thin button cell that has a cross sectional thickness that preferably is no greater than two millimeters. In a preferred embodiment, each button cell 168 is a three volt button cell, such as preferably a CR2016 lithium button cell having a cross sectional thickness of no more than about 1.6 millimeters and a diameter of no more than about twenty millimeters.

As relative movement between bookmark segments 22, 24 occurs from manipulation of the bookmark 20a toward the reading light operating position 30, the gap between the movable contact 128 and fixed contact 130 lessens until an electrical connection is made between the two contacts 128, 130 energizing the light 26 causing it to light up. As relative movement between bookmark segments 22, 24 occurs from manipulation of the bookmark 20a away from the reading light operating position 30 toward the bookmark position 28, the torsion spring 136 causes the movable contact 128 to move away from the fixed contact 130 breaking the electrical connection between the two contacts 128, 130 turning the light 26 off.

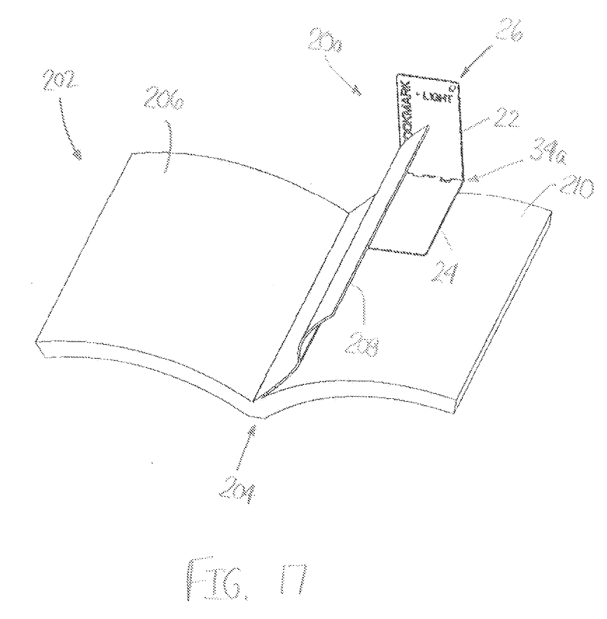

With continued reference to FIG. 14 and additional reference to FIG. 16, as relative movement between the segments 22, 24 occurs in moving towards the reading light operating position 30, a front wall 186 of the pocket 126 in which at least the free end of the actuator loop 124 resides moves in response to relative segment movement displacing the loop 124 into a housing 188 of the light-carrying segment 22 formed by segment halves 52, 54. As the actuator loop 124 is urged into the housing 186, it correspondingly displaces the movable contact 128 toward the fixed contact 130 until the two make physical and electrical contact. When relative segment movement takes place moving the bookmark segments 22, 24 away from the reading light operating position 30, the torsion spring 136 causes the actuator loop 124 to follow the movement of the front pocket wall 186 in response to relative segment movement. This, in turn, causes the movable contact 128 to correspondingly move away from the fixed contact 130 until both physical and electrical contact is broken.

In a preferred embodiment, the contacts 128, 130 make an electrical connection when the included angle between the bookmark segments 22, 24 is between 150° and 135° and break the electrical connection when the included angle between the bookmark segments 22, 24 is between 135° and 150°. Therefore, in one preferred embodiment, the light 26 of the bookmark 20a will remain off when the included angle between bookmark segments 22, 24 is between about 180° and about 150° and turns on when the included angle between segments 22, 24 is less than about 150°. In another preferred embodiment, the light 26 of the bookmark 20a will remain off when the included angle between bookmark segments 22, 24 is between about 180° and about 130° and turns on when the included angle between segments 22, 24 is less than about 130°. Preferably, depending on the desired configuration sought to be achieved, the turn on/turn off range can vary between ±15′ of the 135° included angle position.

To limit relative segment movement, hinge knuckles 80 and 82 each have an over-rotation stop 190, shown in FIG. 14, which prevents the segments 22, 24 from rotating more than about five degrees beyond the approximately 180° bookmark operating position 28. Each stop 190 is a projection that extends outwardly from a rounded knuckle edge that bears against part of an end wall 192, 192′ of a corresponding knuckle receptacle 194, 194′ formed in the anchor segment 24. Each over-rotation stop 190 is disposed on the bottom surface of knuckles 80, 82.

One of the knuckles 80 has an upraised detent projection 196 disposed on the top surface of the knuckle 80 that bears against a resilient detent strip 198 that forms the end wall 192′ of the corresponding knuckle receptacle 194′. The detent strip 198 is disposed between the knuckle receptacle 194′ on one side of the strip 198 and a clearance recess 200 on the other side of the strip 198. During relative segment rotation toward the reading light operating position 30, the detent projection 196 comes into contact with the detent strip 198 elastically deforming the strip 198 such that part of it bends into the clearance recess 200 until further relative segment rotation enables the detent projection 196 to clear the strip 198. When the reading light position 30 is reached, the detent projection 196 clears the strip 198. However, interference between the detent projection 196 and the strip 198 opposes relative segment rotation away from the reading light operating position 30 toward the bookmark operating position 28 thereby releasably retaining the segments 22, 24 in the reading light operating position 30.

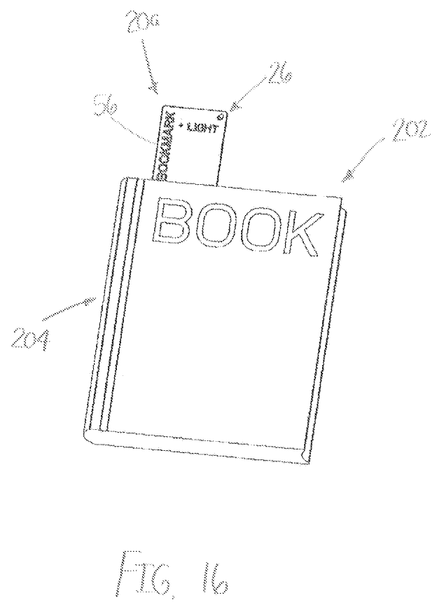

Preferably, at least the knuckle 82 opposite the detent projection carrying knuckle 80 has an over-rotation stop 190. In the preferred multi-function bookmark embodiment depicted in FIGS. 14 and 15, both knuckles 80, 82 are equipped with an over-rotation stop 190 on one side with one of those same knuckles 80 having a detent projection 196 on its other side. Such a knuckle construction enables the segments 22, 24 to be stably disposed in line with one another forming a substantially planar bookmark when it is desired to use the multi-function bookmark 20a as a bookmark. It also enables the segments 22, 24 to be moved relative to one another until they are substantially perpendicular to one another preferably having an included angle between their segments that is no less than about 80° and no greater than about 100° to thereby retain the segments in a desired optimal reading light operating position 30. In a preferred embodiment, the angle between the segments is between 80° and 90° when the segments are disposed in a preferred reading light operating position.

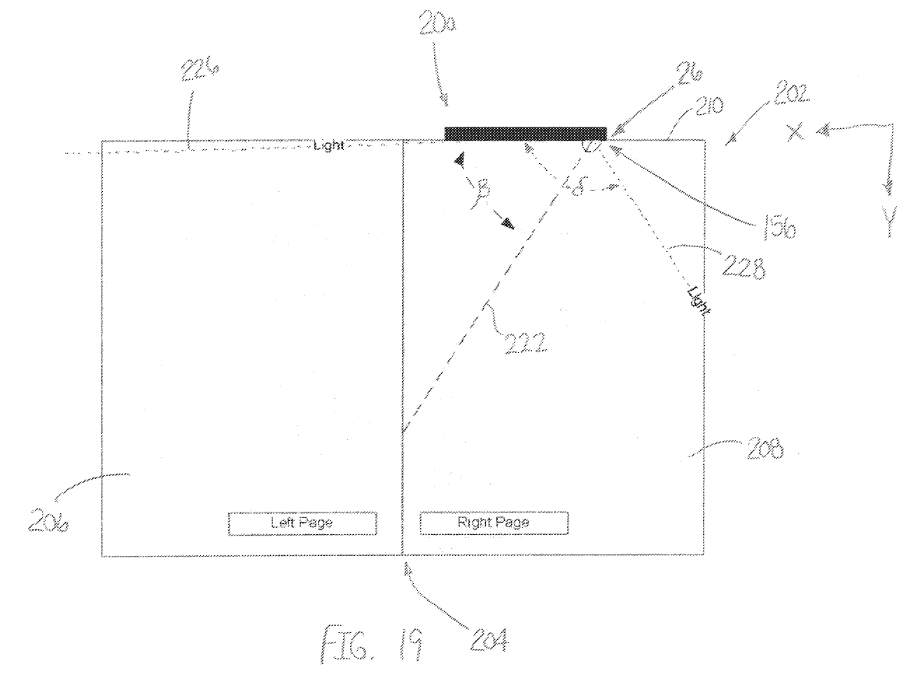

FIGS. 16-18 illustrate use and operation of a preferred embodiment of a multi-function bookmark 20a constructed in accordance with the present invention. FIG. 16 illustrates the bookmark 20a with its segments 22, 24 disposed in the substantially flat or planar bookmark operating position 28 and inserted in between a pair of pages of a book 202. As previously discussed, the bookmark 20a preferably has a tapered edge 56 disposed toward a spine 204 of the book 202 such that the tapered edge 56 helps position the bookmark 20a closer to the spine 204, which more positively helps retain the bookmark 20a in the book 202.

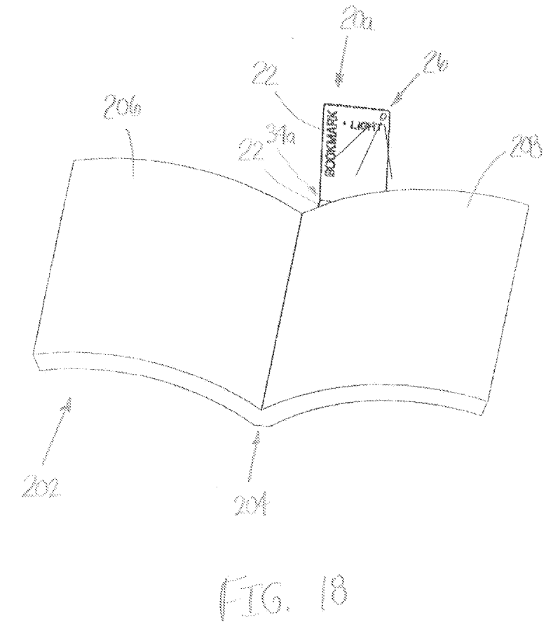

FIG. 17 illustrates the book 202 opened to display a plurality of pairs of pages 206, 208 and 208. While the pages shown in FIG. 17 are consecutive pages, the bookmark 20a, when used in its reading light operating capacity, can be inserted between any adjacent pair of pages adjacent the pair of pages 206, 208 being viewed by a reader of the book 202. For example, the anchor segment 24 of the bookmark 20a can be inserted as many as five, ten or twenty pages behind the page 208 on that same side that is currently being presented for reading.

As the bookmark segments 22, 24 are manipulated into the reading light operating position 30, the reading light 26 turns on illuminating at least a portion of one of the pages 206, 208 being presented for reading to a reader of the book 202. In a preferred embodiment, at least the page 208 on the same side of the book in which the bookmark anchor segment 24 has been inserted is illuminated by the light 26. In another preferred embodiment, the light 26 illuminates both of the pages 206, 208.

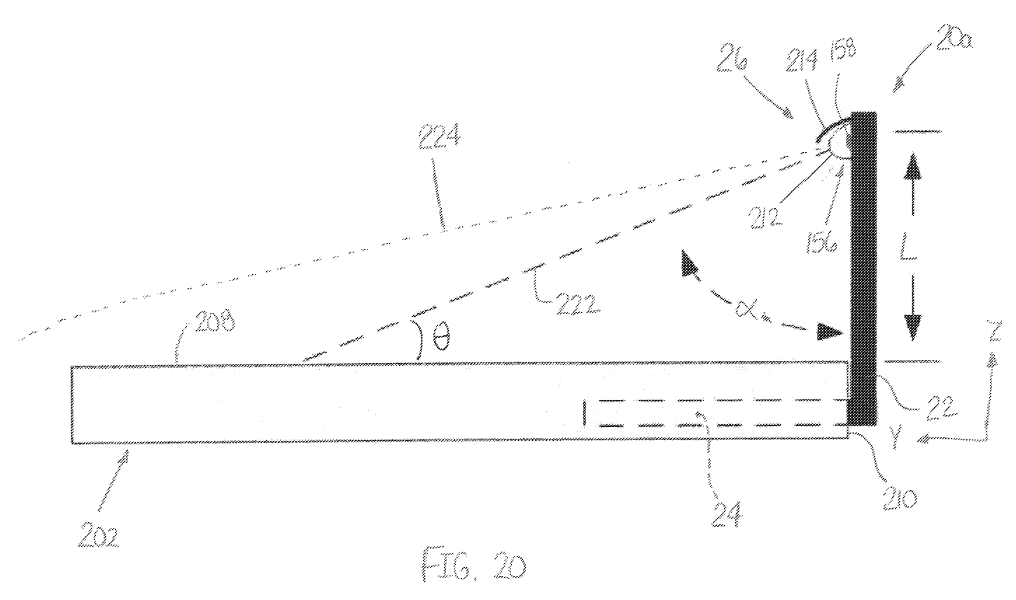

FIGS. 19 and 20 illustrate use of the bookmark 20a in its reading light operating position 30 to illuminate portions of both adjacent pages 206, 208 of the opened book 202 that are both presented for reading by a reader of the book 202. In the preferred embodiment depicted in FIGS. 19 and 20, the anchor segment 24 (shown in phantom in FIG. 20) is inserted between a pair of pages a distance below page 208 that can be as little as a single page and can be as much as a plurality of pages or more. The reading-light carrying segment 22 is abutted against a top edge 210 of the pages on one side of the book 202. In the present example, the reading-light carrying segment 22 is abutted against the top edge 210 of the pages on the right side of the book 202.

As previously described, the reading light 26 includes a light source 156, such as a light emitting diode 158 or miniature incandescent bulb, which includes a focusing lens 212 (FIG. 20) that overlies the source and extends outwardly from it. To help prevent a reader from being adversely affected by glare, the light-carrying segment 22 preferably also includes a shroud 214 that extends outwardly from the top surface of the segment 22 and that is located between the light source 156 and reader. In a preferred embodiment, such as depicted in FIGS. 1-4 and 20, the shroud 214 can be part of a light socket housing 216 that extends outwardly from the segment housing 188 at an acute angle relative to its top or outer surface.

The light 26 is spaced from the joint 34a between the segments 22, 24 such that it preferably is distal to the joint 34a, such as is shown in FIG. 1. Where the segment 22 that carries the light 26 is generally rectangular, the light 26 preferably is located at or adjacent one of the corners 218, 220 of segment 22 disposed opposite the joint 34a. In the preferred bookmark embodiment shown in FIG. 1, the light 26 is disposed in corner 220 of bookmark segment 22.

As is shown in FIG. 20, the light-carrying segment 22 has a length, L, which disposes the light 26 at least two inches above the page 208 being presented for viewing and preferably about three and a half inches above the page 208. Preferably, the length, L, is not more than 5 inches above the page 208 and not less than 2 inches above the page 208 to help ensure optimal illumination of at least page 208 and preferably page 206 and page 208.

To help ensure illumination of at least the page 208 on the same side of the book 202 as the bookmark 20a is located, the light source 156 is oriented so its optical or focal axis 222, i.e., optical central light emitting axis, along the Y-Z-axes is disposed at an acute angle. For example, as is shown in FIG. 20, the light source 156 is oriented relative to the top surface of the segment 22 that carries it such that it forms an acute angle, α, of between 30° and 70° to help ensure optimal illumination of at least page 208 and preferably pages 206 and 208. In a preferred embodiment, α, is about 60°±2.50. This produces an illumination pattern whose upper extent relative to the Y-Z axes is delineated by dashed line 224 that encompasses a page having a length extending in a direction away from the light source 156 that is at least 7 inches long.

In the preferred embodiment depicted in FIGS. 19 and 20, θ is the angle between the optical central light emitting axis 222 of the light source 156 and is substantially the same as α as discussed above. Preferably, θ and a suitable range for θ corresponds to the preferred angle and preferred angular range for α discussed in the immediately preceding paragraph.

To help ensure illumination covers both pages 206, 208 where dual page illumination is desired, the light source 156 is oriented so its focal or optical axis 222 along the X-Y axes is also disposed at an acute angle. For example, as is shown in FIG. 19, the light source 156 is oriented relative to the top surface of the segment 22 that carries it such that it forms an acute angle, β, of between 50° and 70° to help ensure optimal illumination of at least pages 206 and 208. In a preferred embodiment, β, is also about 60°±2.5°. This produces an illumination pattern whose outer extents relative to the X-Y axes are delineated by dashed lines 226 and 228 encompassing an angle, δ, of between about 125° and 145° and preferably about 135° as is shown in FIG. 19.

Where a light emitting diode is used as the light source 156, the light emitting diode preferably emits substantially white light, e.g., ultra bright white, at a luminous intensity of at least about 9,000 milli-candelas and preferably between 9,000 and 11,000 milli-candelas. This provides an average luminous flux of at least about 7.5 lumens and preferably between 7.5 lumens and 9.3 lumens.

Where a multi-function bookmark constructed in accordance with the present invention offers a plurality of pairs of functions, it preferably offers a magnifying lens in addition to a reading light. However, other functions can be provided in addition to the reading light. For example, suitable functions that can be incorporated into the bookmark include that of a calculator, thermometer, picture holder, or time keeper, all of which are not shown in the drawings. Where a multi-function bookmark is configured to be able to provide a plurality of pairs of functions, its light preferably can be used at the same time as at least one other function provided is being used.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A multi-function bookmark comprising:
(a) a first bookmark segment;
(b) a second bookmark segment;
(c) a light carried by one of the segments.

2. The multi-function bookmark of claim 1 wherein at least one of the first and second segments is manually movable between a bookmark operating position usable as a page marker where the first and second bookmark segments form a generally planar bookmark and a light operating position where one of the first and second bookmark segments are disposed at an angle relative to the other one of the first and second bookmark segments.

3. The multi-function bookmark of claim 2 further comprising a joint disposed between the first and second bookmark segments that enables relative movement therebetween.

4. The multi-function bookmark of claim 3 wherein the joint comprises at least one detent enabling the first and second bookmarks being movable between the bookmark operating position and the light operating position.

5. The multi-function bookmark of claim 2 further comprising a position activated switch carried by one of the first and second bookmark segments that activates the light when the first and second bookmark segments are disposed in the light operating position.

6. The multi-function bookmark of claim 5 further comprising a source of electrical current onboard one of the segments that provides electrical current to the light when the bookmark segments are disposed in the light operating position.

7. The multi-function bookmark of claim 6 wherein the source of electrical current comprises at least one button cell disposed within one of the bookmark segments and the light comprises a light emitting diode or a miniature incandescent lamp.

8. The multi-function bookmark of claim 5 wherein the position activated switch is disposed within one of the bookmark segments and comprises a switch actuator that cooperates with the other one of the bookmark segments.

9. The multi-function bookmark of claim 2 wherein the bookmark segment opposite the light-carrying bookmark segment comprises a bookmark anchor that is received between a pair of pages of a book underlying a page presented for viewing by a reader of the book when the bookmark segments are disposed in the light operating position wherein the light illuminates at least part of the page presented for viewing when the anchor bookmark segment is received between the pair of book pages underlying the page presented for viewing.

10. The multi-function bookmark of claim 9 wherein the pair of pages between which the anchor bookmark segment is received releasably retains the bookmark therebetween.

11. The multi-function bookmark of claim 9 wherein the light is positioned above the page presented for viewing by a reader of the book.

12. The multi-function bookmark of claim 11 wherein there are a pair of pages presented for viewing by a reader of the book with one of the pages presented for viewing by a reader of the book comprising a right hand page and the other one of the pages presented for viewing by a reader of the book comprising a left hand page and wherein the light is positioned above the right hand page presented for viewing and the left hand page presented for viewing.

13. The multi-function bookmark of claim 1 comprising a plurality of pairs of functions with one of the functions comprising a bookmark and a second one of the functions provided by the light and comprising a reading light.

14. The multi-function bookmark of claim 13 wherein a third one of the functions comprises one of a magnifier, a picture frame, a clock, and a calculator.

15. A multi-function bookmark comprising a light and a plurality of bookmark segments manipulable into a light operating position providing reading lighting where a portion of the bookmark is disposed between a plurality of pages of an opened book underlying a page of the opened book presented for viewing by a reader of the opened book with the light carried by one of the plurality of bookmark segments and disposed at a height that is higher than the page of the opened book presented for viewing.

16. The multi-function bookmark of claim 15 wherein the light comprises one of a light emitting diode and a miniature incandescent light bulb mounted to the bookmark and oriented with an optical central light emitting axis of the light disposed at an acute angle relative to the page of the opened book presented for viewing.

17. The multi-function bookmark of claim 15 wherein the light is mounted to one of the bookmark segments and projects outwardly from an outer surface thereof at an acute angle relative thereto toward the page of the opened book presented for viewing when the bookmark is disposed in the light operating position and received between a plurality of the pages of the opened book.

18. The multi-function bookmark of claim 15 wherein the portion of the bookmark disposed between the plurality of pages is elongate and generally planar when disposed between the plurality of the pages of the opened book releasably anchoring the bookmark to the opened book and wherein there is another portion of the bookmark extending above the page of the opened book presented for viewing when the bookmark is disposed in the light operating position.

19. The multi-function bookmark of claim 18 wherein the portion of the bookmark disposed between the plurality of pages that is elongate and generally planar when disposed between the plurality of the pages of the opened book comprises an elongate and generally planar anchor bookmark segment.

20. The multi-function bookmark of claim 19 wherein the anchor bookmark segment is slidably received between the plurality of pages of the opened book releasably retaining the anchor bookmark segment therebetween.

21. The multi-function bookmark of claim 15 wherein the plurality of the bookmark segments are manipulable between the light operating position and a bookmark operating position where a pair of the plurality of the bookmark segments are receivable between a plurality of pages of a closed book.

22. The multi-function bookmark of claim 21 further comprising an onboard battery, an onboard hinge and an onboard electrical switch arrangement that operably cooperates with the hinge supplying electrical power from the battery to the light when the bookmark is disposed in the light operating position and preventing electrical power from being supplied from the battery to the light when the bookmark is disposed in the bookmark operating position.

23. The multi-function bookmark of claim 22 wherein there are a pair of elongate and generally planar bookmark segments with the hinge disposed therebetween and the light, the battery and the electrical switch carried by one of the pair of bookmark segments.

24. A method of operating a multi-function bookmark comprising:
(a) providing a bookmark comprised of at least a plurality of segments and a light; and
(b) manipulating the plurality of bookmark segments between a light operating position and a bookmark operating position.

25. The method of claim 24 wherein the light emits visible light when the plurality of bookmark segments are disposed in the light operating position and the light is off when the plurality of bookmark segments are disposed in the bookmark operating position.

26. The method of claim 25 wherein a first portion of the bookmark is flat and elongate and receivable between a plurality of pages of a book when the plurality of bookmark segments are disposed in the light operating position and when the plurality of bookmark segments are disposed in the bookmark operating position.

27. The method of claim 26 wherein a second portion of the bookmark extends above a page presented for viewing when the book is opened and the first portion is received between a plurality of pages of the book that underlie the page presented for viewing.

28. The method of claim 27 wherein the first portion and second portion of the bookmark are disposed at an angle relative to each other when the bookmark segments are disposed in the light operating position and wherein the first portion and second portion of the bookmark are disposed in line with one another forming a substantially flat bookmark when the bookmark segments are disposed in the bookmark operating position.

29. The method of claim 28 wherein at least one of the plurality of bookmark segments comprises an anchor bookmark segment is generally planar and elongate that is receivable between a plurality of pages of the book that underlie the page presented for viewing when the book is opened and wherein the light is carried by another one of the plurality of segments and disposed above the page presented for viewing when the anchor bookmark segment is received between the plurality of pages of the book when opened.

30. The method of claim 29 wherein the light illuminates substantially all of the page presented for viewing when the bookmark is disposed in the light operating position.

31. The method of claim 30 wherein the light illuminates substantially all of a second page located adjacent the page presented for viewing.
